(19) United States
(12) Patent Application Publication
(10) Pub. No.: US 2012/0006981 A1
(43) Pub. Date: Jan. 12, 2012

(54) WAVEGUIDE INTEGRATED PHOTODETECTOR

(75) Inventors: Pol Van Dorpe, Spalbeek (BE); Pieter Neutens, Sint Andries (BE)

(73) Assignee: IMEC, Leuven (BE)

(21) Appl. No.: 13/142,830

(22) PCT Filed: Mar. 13, 2010
(86) PCT No.: PCT/EP2010/054372

§ 371 Date: Jun. 29, 2011

Related U.S. Application Data
(60) Provisional application No. 61/164,993, filed on Mar. 31, 2009.

(51) Int. Cl. G01J 1/42

(52) U.S. Cl. 250/227.11

(57) ABSTRACT

A waveguide integrated photodetector (100) is described. The waveguide integrated photodetector comprises a first layer (110) of plasmon supporting material whereby the first layer (110) has an input slit (112) extending through the first layer (110) for coupling first radiation to the waveguide. The photodetector (100) also comprises a second layer (120) of plasmon supporting material facing the first layer and separated from the first layer by a first distance in a first direction. The second layer (120) has an output slit (122) extending through the second layer (120) and separated from the input slit (112) by a second distance extending along a second direction differing from first direction. The photodetector system (100) also comprises a dielectric layer (130) interposed between the first layer (110) and the second layer (120), and a detector (140) near the output slit (122) for detecting the radiation coupled out through the output slit (122).

### FIELD OF THE INVENTION

The present invention relates to the field of detection. More particularly, the present invention relates to methods and systems for optical detection as well as methods for making such systems.

### BACKGROUND OF THE INVENTION

The operation of surface plasmon waveguides has mainly been demonstrated using optical techniques such as scanning near field microscopy and spectroscopy, for mid and long-range surface plasmon polariton (SPP) waveguides and also for short-range metallic waveguides with high field confinement. Although the methods mentioned above provide excellent means to probe the properties of surface plasmons, none of them can be readily integrated in active plasmonic devices.

US 2009 0027681 refers to the electrical detection of surface plasmons by a GaAs photoconductor coupled to a plasmonic cavity.

### SUMMARY OF THE INVENTION

It is an object of embodiments of the present invention to provide good methods and systems for detecting. It is an advantage of embodiments according to the present invention that a waveguide integrated detector can be provided with small footprint. The above objective is accomplished by a method and device according to the present invention. The present invention relates to a waveguide integrated photodetector comprising a first layer of plasmon supporting material, said first layer having an input slit extending through the first layer for coupling first radiation to a waveguide, a second layer of plasmon supporting material facing the first layer and separated from the first layer by a first distance in a first direction, the second layer having an output slit extending through the second layer and separated from the input slit by a second distance extending along a second direction differing from the first direction, a dielectric layer interposed between the first layer and the second layer, the combined first layer, dielectric layer and second layer acting as the waveguide, and a detector near the output slit for detecting the radiation coupled out through the output slit.

It is an advantage of embodiments according to the present invention that a good detection efficiency can be obtained due to the coupling of the radiation to surface plasmon polaritons, the detection being performed near the second layer.

The detector may be any of in direct contact with the second layer, local to the second layer or in the near field of the second layer.

The waveguide integrated photodetector may comprise a means for altering the optical characteristics of excitation radiation resulting in said first radiation.

The means for altering the optical characteristics of the excitation radiation may be positioned in the input slit. The means for altering the optical characteristics alternatively may be positioned close to the input slit. The means for altering the optical characteristics may be a presence of fluorophores, quantum dots etc. It can be in the slit, above the slit or next to the slit, but then close to the metal film. Close to the input slit may be between 10 and 100 nm above the metal film and within 20 micrometer from the slit. For fluorophores above the slit, close to the slit may comprise between 10 nm and 20 micrometer directly above the slit.

The means for altering the optical characteristics may comprise any of fluorescent molecules, phosphorescent molecules, quantum dots, doped nanoparticles, nanoparticles having luminescent properties, magneto-optically active nanoparticles. The means for altering the optical characteristics may be a means for altering the wavelength and or the polarization of the excitation radiation.

In one embodiment, the means for altering the optical characteristics of the impinging light affects at least one characteristic of light impinging on said input slit. The at least one characteristic can be, for example, the polarization of the electromagnetic radiation or the wavelength of the electromagnetic radiation.

The input slit may be adapted for coupling in the first radiation and for rejecting the excitation radiation. In a further embodiment of the first aspect of this invention, in a waveguide integrated photodetector as recited in any of the other embodiments, the means for altering the optical characteristics of the impinging light can comprise fluorescent molecules. The fluorescent molecules can bind another molecule (such as, but not limited hereto, a biomolecule, a target molecule), and can have luminescent properties.

The interface between the first layer and the dielectric layer may support a first surface Plasmon mode. It is an advantage of embodiments according to the present invention that a local plasmon mode can be generated at the interface between the first layer and the environment (such as, but not limited hereto, air or water) in the input slit. This propagates as a propagating waveguide mode in the combined first layer, dielectric layer and second layer.

The interface between the first layer and the dielectric layer may support a second surface Plasmon mode. The MIM waveguide may support depending on the thickness of the dielectric coupled or decoupled surface plasmon modes (the thinner, the more the modes on the two metal/dielectric interfaces are coupled)

The input slit may be adapted for collecting radiation with a predetermined polarization.

The thickness of the first layer may be selected such that the first layer is optically opaque.

The thickness of the second layer may be selected such that the second layer is optically opaque.

The thickness of the dielectric layer may be selected such that the first layer and the second layer optically interact.

The thickness of the dielectric layer may be selected such that the electromagnetic radiation optically couples to the photodetector.

The second distance may be selected longer than the evanescent tail of the excitation wavelength in the input slit. It is an advantage of embodiments according to the present invention that direct coupling between the excitation radiation and the photodetector is prevented.

The dielectric layer may be capable of supporting one or multiple propagating waveguide modes.

The first layer may be a metal. The second layer may be a metal.

The detector may comprise a semiconducting layer.

The waveguide integrated photodetector may be adapted for electrical detection of surface plasmon polaritons in metallic slot waveguides.

The photodetector may be an integrated metal semiconductor metal photodetector.

The waveguide integrated photodetector may furthermore comprise a filtering means for filtering excitation radiation from said first radiation.

The filtering means may be a Bragg reflector.

The filtering means may comprise a filtering mechanism based on transmission properties of the first radiation and the excitation radiation in the waveguide.

The present invention also relates to a method for detecting an optical signal, the method comprising—directing an excitation radiation beam on an altering means for altering optical characteristics of the excitation radiation beam to obtain first radiation, obtaining said first radiation through alteration of the excitation radiation beam, coupling said first radiation via an input slit to a waveguide and propagating said radiation using surface plasmon polaritons towards an output slit, and detecting said first radiation coupled out through said output slit.

The method furthermore may comprise filtering the excitation radiation beam from the first radiation beam.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 shows a schematic illustration of components of a waveguide integrated detector according to an embodiment of the present invention.

FIG. 2 illustrates a schematic representation of a Bragg reflector, as can be used in a waveguide integrated detector according to an embodiment of the present invention.

FIG. 3a and FIG. 3b illustrate reflectivity as function of a structural parameter of a Bragg reflector as described in FIG. 2, as can be used in embodiments of the present invention.

FIG. 4 is a schematic representation of a MIM-MSM as can be used in a waveguide-integrated MSM detector according to one embodiment of the invention.

FIG. 5 is a scanning electron micrograph of a device according to FIG. 4, in which the positions of the injection and detection slits are marked by the triangles.

FIG. 6a and FIG. 6b show the numerical calculations for plane wave excitation wherein FIG. 6a shows TE polarization and FIG. 6b shows TM polarization in the system, for the system as shown in FIG. 5a.

FIG. 7 provides IV curves for different laser intensity. Current amplifications up to 600 are measured. The dark current is presented more clearly in the inset of the figure, revealing a clear back-to-back Schottky characteristic.

FIG. 8a and FIG. 8b provides MSM photocurrent measurements as a function of the laser spot position, illustrating features of embodiments of the present invention, wherein FIG. 8a shows 2D photocurrent maps for an injection-detection distance of 8 μm and FIG. 8b shows photocurrent line scans over the middle of the waveguide in TM polarization for different distances between injection and detection slit.

FIG. 9a and FIG. 9b provides additional MSM photocurrent measurements as a function of the laser spot position. FIG. 9a provides spectral responses of the waveguide-integrated detectors (bottom) and the corresponding calculated photo absorption spectra, whereas FIG. 9b provides a comparison between the calculated e⁻¹ decay lengths and the experimental values.

FIG. 10 illustrates an exemplary structure used for simulation of a waveguide integrated detector according to an embodiment of the present invention.

FIG. 11a and FIG. 11b illustrate the electric field components in different directions for different orientations of fluorophore dipoles for a system according to FIG. 10.

FIG. 12a to FIG. 12d illustrate charge density plots for different orientations and positions of the fluorophore dipoles in a system according to FIG. 10.

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

Where in embodiments of the present invention reference is made to a waveguide, reference is made to the combined stack of the first layer, the dielectric layer and the second layer, whereby the guided mode propagates as a plasmonic mode in the combined stack.

Where in embodiments of the present invention reference is made to an input slit, reference is made to a via which may be in the form of a channel, a hole, a pore, etc. Where in embodiments of the present invention reference is made to direct contact, reference is made to contact whereby no other material is between the two components making direct contact.

In a first aspect, embodiments of the present invention relate to a waveguide integrated photodetector, also referred to as waveguide integrated photodetector system. The waveguide integrated photodetector according to embodiments of the present invention may be especially suitable for fluorescence detection and applications in for example bio-sensing, although embodiments of the present invention are not limited thereto. Some other examples of applications may be fast detecting for on-chip optical communication, fast small pixels for high density cameras, etc. The waveguide integrated photodetector according to embodiments of the present invention comprises a first layer of plasmon supporting material, such as for example metal although embodiments of the present invention are not limited thereto. As a surface plasmon polariton can exist at the interface between a conductor and a dielectric, more specifically at the interface between two materials exhibiting a permittivity with a different sign, the surface plasmon supporting material can be a metal, such as Au, Ag, Cu, Al, Ni, . . . . This first layer comprises an input slit extending through the first layer for coupling first radiation to a waveguide. The first radiation may be radiation induced by excitation using an excitation beam. The waveguide integrated photodetector also comprises a second layer of plasmon supporting material facing the first layer and separated from the first layer by a first distance in a first direction. The spacing thereby is obtained at least through a dielectric layer being interposed between the first layer and the second layer. The second layer comprises an output slit extending through the second layer and separated from the input slit by a second distance extending along a second direction differing from first direction. The output slit thereby is adapted for coupling out first radiation. The waveguide integrated photodetector furthermore comprises a detector near the output slit for detecting the radiation coupled out through the output slit.

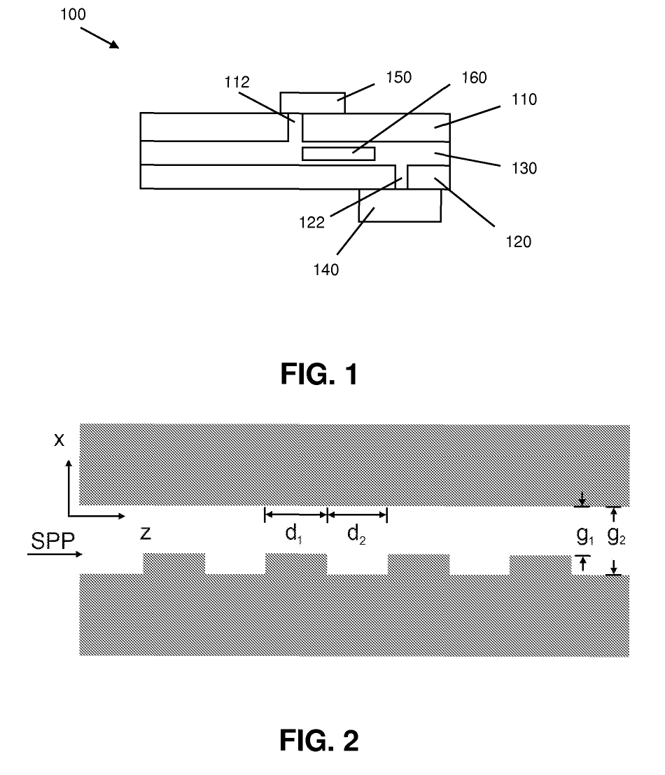

By way of illustration, embodiments of the present invention not being limited thereto, the different components of the waveguide integrated detector will be discussed in more detail with reference to FIG. 1.

FIG. 1 shows a waveguide integrated photodetector 100. The waveguide integrated photodetector 100 comprises a first layer 110 of plasmon supporting material. Such a first layer 110 may be a metal layer, although embodiments of the present invention are not limited thereto. The metal can be, for example as indicated above, or for example selected from the group consisting of gold, silver, copper, aluminum, tin, nickel and alloys and combinations thereof. The thickness of the first layer 110 may be selected such that the first layer is optically opaque. In an embodiment, the thickness of the first layer is at least 200 nm. In another embodiment, the thickness of the first layer is at least 50 nm, or at least 100 nm, or at least 200 nm, or at least 300 nm, or at least 500 nm or higher. The first layer 110 comprises an input slit 112 extending through the first layer for coupling first radiation to a waveguide. The slit can, for example, be in the plane of the materials and its sidewalls can be either straight or slanted. The slit width can vary, for example, between 10 and 1000 nm or between 10 nm and 500 nm. The input slit 112 may be adapted for receiving light with a predetermined polarization. The input slit 112 allows coupling of the first radiation to a further waveguide.

The waveguide integrated photodetector 100 also comprises a second layer 120 of plasmon supporting material. Such material may be for example a metal layer although embodiments of the present invention are not limited thereto. The metal can be, for example, selected from the group consisting of gold, silver, copper, aluminum, tin, nickel and combinations thereof. In certain embodiments, both the first layer 110 and second layer 120 are metal. The second layer 120 may have a thickness of at least 200 nm. In another embodiment, the thickness of the second layer 120 is at least 50 nm, or at least 100 nm, or at least 200 nm, or at least 300 nm, or at least 500 nm or higher. The second layer 120 is facing the first layer 110 but is spaced therefrom. The spacing thereby is obtained at least through a dielectric layer being interposed between the first layer 110 and the second layer 120, as will be described further. The second layer 120 comprises an output slit 122 extending through the second layer and separated from the input slit. The output slit 122 may have a size between 20 and 500 nm or between 50 and 300 nm. The output slit 122 may be at a second distance from the first slit, the second distance extending along a second direction differing from first direction. The second distance can be, for example, between 1 μm and 20 μm, or between 1 μm and 15 μm. The output slit 122 thereby is adapted for coupling out first radiation.

The waveguide integrated photodetector 100 furthermore comprises a dielectric layer 130 spacing the first layer 110 and the second layer 120. The dielectric layer 130 in combination with the first layer and the second layer, behaves as a waveguide and allows propagating the first radiation beam, using surface plasmon polaritons. The dielectric layer may comprise a dielectric material 130. The dielectric layer 130 can, for example, be selected such that it is possible to propagate the electromagnetic wave in the first layer 110, dielectric layer 130, second layer 120 stack as plasmonic mode. The wavelength of the electromagnetic wave can be predetermined. The dielectric material can also be electrically isolating. The dielectric material can be selected from preferentially non-absorbing dielectrics such as SiO₂, Al₂O₃, HfO₂, Si, GaAs Ta₂O₅, SiN, GaN, HfO₂, ZrO₂, MgO, air, vacuum, and its thickness can vary between 10 and 1000 nm.

The waveguide integrated photodetector 100 furthermore comprises a detector 140 near the output slit 122 for detecting the radiation coupled out through the output slit 122. The detector 140 may be any suitable detector. The detector 140 may for example comprise a semiconducting layer. The change in conductivity in the semiconducting layer can be measured in certain embodiments. The semiconducting material can comprise, for example, GaAs, Si, Ge, SiGe, InGaAs, GaN, InGaN, InAlGaAs, GaP, InGaP, CdTe. The semiconducting layer comprises a material being capable of receiving guided optical radiation. The semiconducting layer comprises an active region of III-V semiconducting material. In certain embodiments, a pair of electrodes contacts the active region. The detector 140 may be an integrated metal semiconductor metal photodetector. It is an advantage of embodiments according to the present invention that by means of an integrated metal-semiconductor-metal (MSM) photodetector, highly confined surface plasmon polaritons in a metal-insulator-metal (MIM) waveguide can be detected and characterized. Moreover, due to the small area of the MSM photodetector and the effective coupling between the waveguide and the detector, the noise can be very low, giving rise to high signal-to-noise ratios. Also, as the small area implies a small capacitance, the detector can be very fast (>100 GHz).

In some embodiments, examples thereof being described further in the application, the waveguide integrated photodetector 100 also may comprise an alteration means 150 for altering optical characteristics of an incident excitation radiation beam, the resulting radiation beam then being the first radiation beam. The alteration means 150 may for example comprise fluorophores, allowing to use embodiments of the present invention for fluorescence measurements. In some embodiments, the means for altering the optical characteristics 150 comprises any of fluorescent molecules, phosphorescent molecules, quantum dots, doped nanoparticles, nanoparticles having luminescent properties, magneto-optically active nanoparticles. The alteration means 150 for altering the optical characteristics of the impinging light may be selected such that it emits electromagnetic radiation after excitation by impinging radiation, wherein at least one characteristic of the electromagnetic radiation is altered with respect to the impinging radiation. In an embodiment, the at least one characteristic of the electromagnetic radiation is the wavelength of the electromagnetic radiation. In another embodiment, the at least one characteristic of the electromagnetic radiation is the polarization of the electromagnetic radiation. The polarization of the impinging radiation is altered such that the emitted electromagnetic radiation can be coupled into the input slit 112.

In some embodiments wherein an alteration means 150 is present or is used, a filtering means 160 may be present for separating the excitation radiation from the first radiation. Such a filtering means 160 may be selection of properties of the different layers of the system or may be an additional component such as for example a polarization filter or Bragg reflector. By way of illustration, embodiments of the present invention not being limited thereto, an example of a Bragg reflector will be illustrated further.

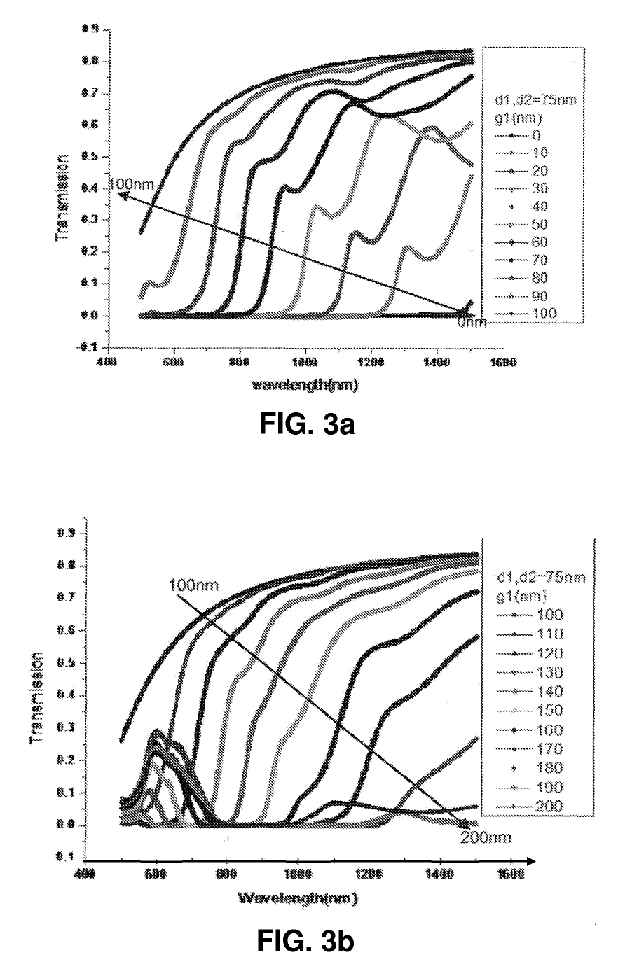

The excitation radiation filtering means may be based on the properties of the waveguide itself. For example, the waveguide properties can be selected such that the propagation distance for the excitation wavelength radiation is strongly reduced, while the propagation distance for the response radiation is sufficiently long for reaching the detector. For example in case of a MIM-based waveguide, the intrinsic properties of MIM-based plasmonic waveguides include strong dispersion of the optical properties: for energies closer to the plasmon resonance energy, the confinement of the plasmons increases (the wavelength gets shorter), but simultaneously the losses increase and the propagation length gets shorter. Combined with the enhanced losses in Au below 600 nm (due to the interband transitions), there is a sharp increase of the propagation length above 600 nm. The slope and this increase can be tuned by playing with the both thickness of the dielectric spacer and its refractive index. The excitation radiation filtering means 160 may be a polarisation filtering means, e.g. if the excited radiation has a particular polarisation. For instance, the polarization of the emitted light by fluorophores in solution is generally altered compared to the polarization of the exciting light. The excitation radiation filtering means in some embodiments may be additional filtering means like waveguide integrated reflectors, such as for example waveguide integrated Bragg reflectors, stubs in the waveguide designed for the excitation wavelength. Such reflectors can be designed such that radiation at the excitation wavelength can be reflected while radiation at the emission wavelength is transmitted. By way of illustration, embodiments of the present invention not being limited thereby, an example of a Bragg reflector is shown in FIG. 2 and the transmission behaviour for different wavelengths is plotted as function of a structural parameter of the Bragg reflector in FIGS. 3a and 3b. The Bragg reflector comprises a plurality of grooves present in part of the waveguide. For a given width d₁ and pitch d₂ of the grooves (d₁=75 nm, d₂=75 nm) and for a given diameter g₂ of the waveguide layer, in the present example being 100 nm, the effect of the height of the grooves protruding from the second layer on the reflection behaviour (for g1 being between 0 nm and 100 nm) or of the depth of the grooves in the bottom (for g1 being between 100 nm and 200 nm) is illustrated by expressing the transmission behaviour as function of the distance g1 between the grooves positioned on one side of the waveguide on the one hand and the other side of the waveguide on the other hand. FIG. 3a illustrates the effect for spacings between grooves and the first layer varying from 0 nm to 100 nm, while FIG. 3b illustrates the effect for grooves in the second layer. It can be seen that an appropriate selection of the spacing can result in reflection of certain wavelengths while transmitting other wavelengths with little loss. For example, selecting a spacing of 120 nm between the upper side of the grooves and the side wall of the waveguide, wavelengths below about 640 nm will be reflected while wavelengths above 640 nm will be transmitted with little loss. The obtained results used for illustrating some possibilities of the present invention are based on finite-difference time domain simulations of the behaviour of a Bragg reflector.

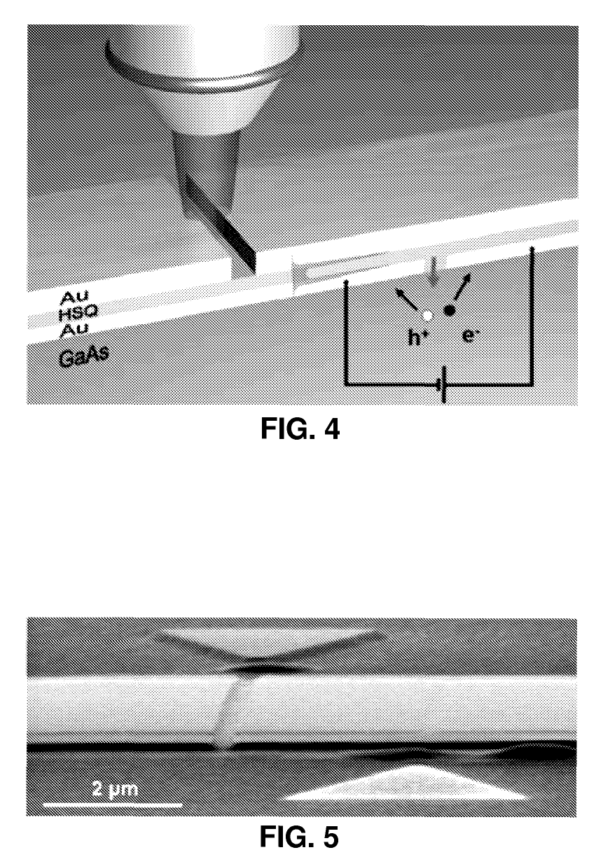

According to embodiments of the present invention, a waveguide integrated photodetector can be provided that allows remote electrical detection of a strongly confined surface plasmon polariton (SPP) mode in a scalable high-bandwidth metallic waveguide. Some particular embodiments therefore combine a metal insulator metal (MIM) waveguide with an inherently fast nanoslit metal-semiconductor metal (MSM) photodetector, resulting in a device which is scalable down to the nanoscale, allowing an operational plasmonic circuit having a very small footprint. Metal-insulator-metal (MIM) waveguides offer the prospect of combining a high spatial field confinement together with micrometer range propagation lengths. Metal-based waveguides provide the unique opportunity to send electrical and optical signals through the same guides. The metal layers of the MIM structure are in direct electrical contact with the semiconductor part of a MSM photodetector. MSM photodetectors provide an extremely fast photo response and a high signal-to-noise ratio. A schematic overview of an example of a waveguide-integrated MSM detector is shown in FIG. 4. A detailed process flow is described in the example, below. The structures of the example given by way of illustration were fabricated on a semi-insulating GaAs wafer. By means of molecular beam epitaxy a 1 μm thick undoped GaAs layer was grown as active layer for the photodetector. The MIM waveguide consists of a Au(100 nm)/Hydrogen silsesquioxane (HSQ)(90 nm)/Au(160 nm) layer stack. A 300 nm wide sub-wavelength slit is fabricated in the bottom gold layer which provides two detector contacts and at the same time allows excitation of localized plasmonic modes in the slit. Excitation of a SPP mode in the waveguide is achieved with a 300 nm slit etched into the top metal layer. The distance between injection and detection slit is varied from 0 to 12 μm in steps of 1 μm. A side view scanning electron micrograph of a fully processed device is presented in FIG. 5.

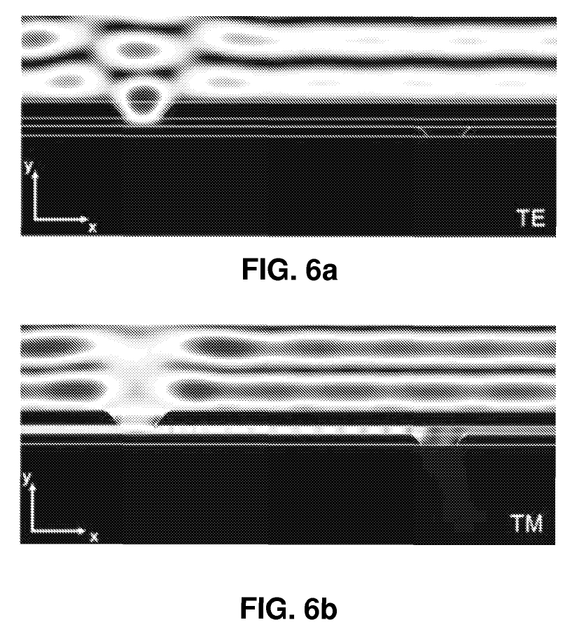

The device was rigorously modelled and optimised by performing 2D numerical calculations using Comsol Multiphysics. Simulated normalized electric field profiles for TE (E⊥z-axis) and TM (E∥z-axis) polarization are shown in FIG. 6a and FIG. 6b. The entire structure is illuminated by a plane wave propagating in the y direction. Due to the one-dimensional geometry of the injection slit no efficient SPP excitation is expected when E is set parallel to the z-axis (H perpendicular). For Ag/SiN₄/Ag MIM waveguides simulations indicate that conventional waveguide modes with very short propagation distances can be addressed for small free space wavelengths (<600 nm) in TE polarization in case the thickness of the insulating layer exceeds 100 nm. Given the wavelength range of interest in our experiments (600 nm to 875 nm) and taking into account the lower index HSQ core (n=1.43 no contributions of conventional waveguide modes or plasmonic modes in the TE polarization are expected.

For TM polarization, the plane wave excites a local plasmonic mode in the injection slit which couples very efficiently to a propagating mode in the waveguide located in its near field. Simulations (data not shown) indicate that for excitation wavelengths from 650 nm to 875 nm, respectively 40 to 65 percent of the light falling onto the slit couples to SPPs. The coupling mechanism is illustrated in FIG. 6a and FIG. 6b by the interference patterns above the waveguide. While the interference pattern vanishes above the slit for TM polarization (as there is little reflection due to a good modal coupling between the light incident to the slit and the waveguide mode), the interference pattern is still present for TE polarization.

SPP detection is established by coupling back to a local mode governed by the sub-wavelength detection slit. Coupling to the local plasmonic mode in the detection slit is achieved with an efficiency of more than 60 percent for wavelengths between 700 and 850 nm. The largest loss is caused by partial transmission of SPPs across the detection gap. Only a small ratio (<5 percent) is reflected (data not shown). The large index of GaAs leads to strong modal confinement in a volume of the semiconductor located right between the electrodes of the MSM detector. The modal confinement largely restricts photo absorption to a small area in the semiconductor corresponding to the high-electric-field region, thereby greatly reducing the average collection distance and transit times.

Monte Carlo simulations performed earlier on interdigitated epitaxially grown GaAs MSM detectors with narrow gaps demonstrate intrinsic response times ranging between ˜0.25 ps and ˜3 ps for gap widths between ˜25 and ˜500 nm, making these type of detectors very suitable for high-bandwidth applications. By fabricating MSM detectors with similar gaps and taking advantage of plasmon enabled modal confinement, similar or shorter photo-response times are feasible for our samples. For example, for our (experimentally realized) gap widths of 40 to 300 nm, one can tentatively calculate the drift dominated response time of our MSM detector, τ=˜0.3 to ˜2.5 ps. To account for RC delays, the capacity of the devices was calculated. The device capacitance is dominated by the parallel plate capacitance of the MIM waveguide. Based on Chou et al and using their equation f_{3dB}=0.441/t, with t the response time, one can also conclude that the resulting transit time limited bandwidth for these devices varies from 176 GHz for 300 nm wide gaps to 1470 GHz for 40 nm wide gaps. The RC-limited bandwidth varies between 240 GHz (width of the waveguide=5 μm, length=20 μm) and 909 GHz (width of the waveguide=1 μm, length=20 μm), which means that for the presented device the bandwidth is in practice transit-time limited.

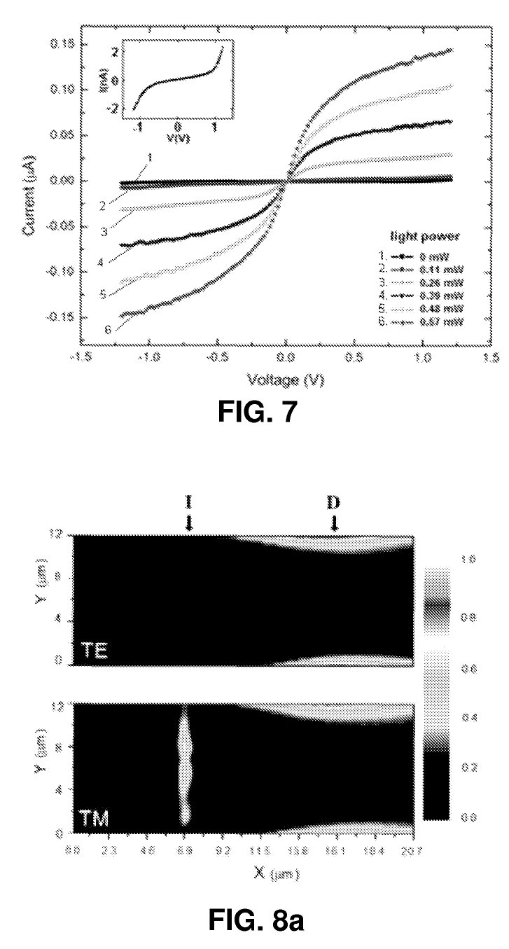

All experimental results presented here were obtained on MIM waveguides with a bottom metal layer width of 6 μm. To determine the optimum bias voltage for the detector, IV curves were measured as a function of the laser output power on a waveguide with a 300 nm gap and zero displacement between injection and detection slit. The resulting graphs are presented in FIG. 7. An autoscaled curve of the dark current is shown in the inset, revealing extremely low dark currents up to 300 pA in the linear regime, illustrating the high quality of the MSM detectors. The highest shot noise limited signal-to-noise ratio (10³ at modest light intensity) is found when a voltage of around 0.5 Volts is applied across the detector. Consequently the bias voltage is set to 0.5 V in all of the following measurements. By measuring the laser power incident on the detector and the corresponding photocurrent, the detectors' external quantum efficiency was calculated to be 8.9 to 34.3 percent for respectively 1 V to 10 V.

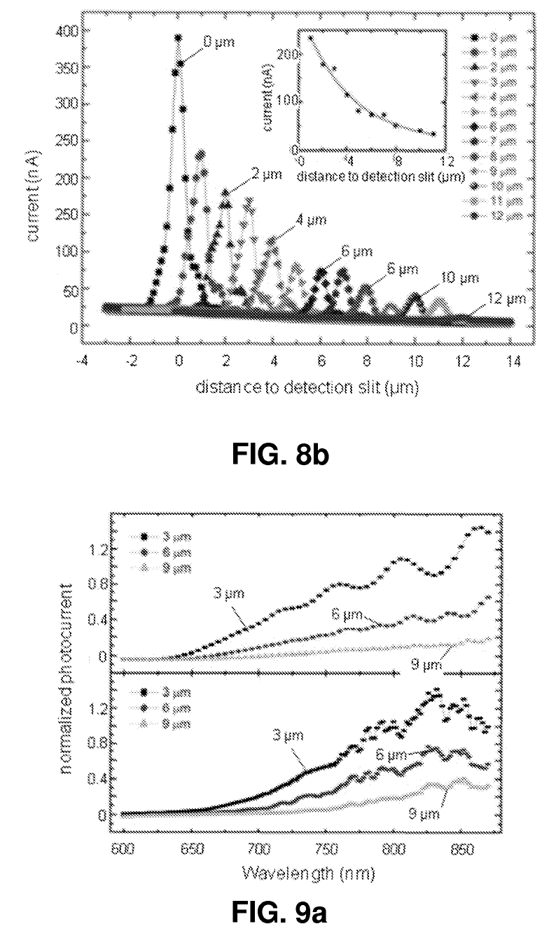

In a first set of experiments the remote SPP detection with the GaAs MSM detector by means of polarization dependent measurements is demonstrated. In FIG. 8a photocurrent maps are shown that are normalized with respect to the laser intensity of a MIM-MSM device with an 8 μm separation between the slits for TE and TM polarization. The position of the injection and detection slits is marked by the arrows indicated respectively with I and D. The excitation wavelength is 800 nm. In the case of the TE polarization (top) only a very small absorption enhancement is detected when the laser spot scans over the SPP injection slit, indicating that no surface plasmon modes or conventional waveguide modes are excited. In the measurement with TM polarization (bottom), a huge photo-response is observed.

This enhanced response is attributed to the remote detection of SPPs launched at the injection slit. In order to investigate the decay of the SPP energy along the waveguide, line scans in the middle of the waveguide are presented in FIG. 8b for MIM waveguides with injection-detection distances from 0 to 12 μm (λ=720 nm). The position of the detection slit is located at x=0. Due to the field penetration in the metal parts of the waveguide, ohmic losses in the two metal layers cause the SPP energy to decay exponentially as it propagates along the waveguide, as is clearly observed in the measured photocurrent scans. By fitting the photocurrent for injection-detection distances of 1 to 12 μm, a e⁻¹ decay length of 4.7 μm is found for 720 nm. Peaks go from left to right with increasing distances. An exponential decay can be observed.

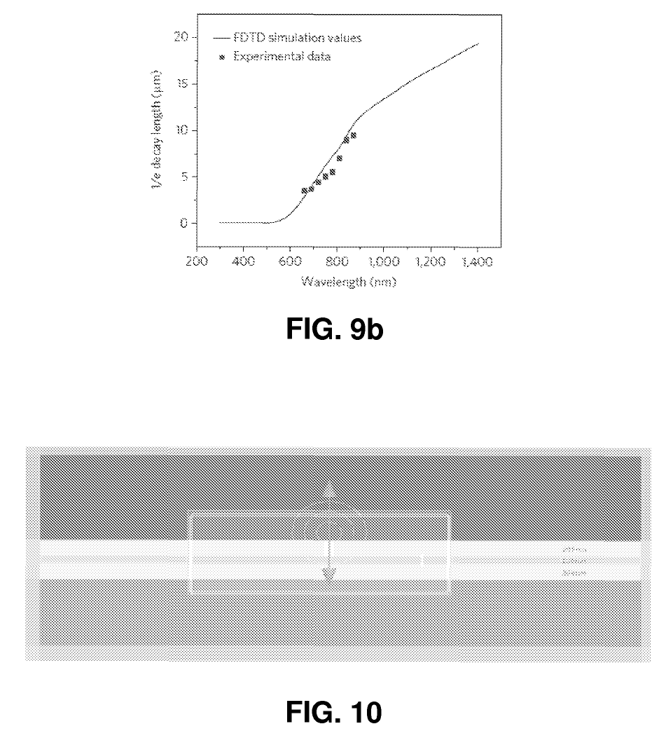

To investigate SPP dispersion in the waveguide, spectral measurements were performed. To eliminate wavelength-dependent features of the light source, the monochromator and other optical components, the measured data are divided by the photo-response of a reference detector containing no SPP features. Also the background signal—independent of the waveguide length—is subtracted from the data to enable a direct comparison with results obtained via numerical calculations. In FIG. 9a the normalized spectral photo-response is plotted as a function of the wavelength in the case of TM polarization (bottom). A clear injection-detection distance dependency is observed, in line with the previously presented experiments. Due to the lower absorption in the metal layers at longer wavelengths, an ascending curve is found in function of the free space wavelength. The results correspond very well to the data obtained with numerical calculations presented in the top part of the figure, which were performed for the same parameters as in the experiment. The finite size of the exciting laser spot prevents the formation of a pronounced interference caused by partial reflections at both slits. Such interference effects lead to the standing wave pattern observed in FIG. 9a. The finite spot size explains why, unlike in the 2D simulations, the experimental spectral data do not show pronounced oscillations. By fitting the photocurrent data for different injection-to-detection distances, e⁻¹ decay lengths of 3.5 μm for 660 nm free space wavelength to 9.5 μm for 870 nm were found.

As an independent check the e⁻¹ decay lengths were determined by using the modesolver of Lumerical FDTD. As can be inferred from FIG. 9b, the investigated MIM waveguide supports e⁻¹ decay lengths from zero up to tens of micrometers. The experimental data points obtained by electrical SPP detection are plotted together with the simulation curve. A good agreement between the experimental and calculated values is observed. All these results corroborate that an integrated MSM detector provides an efficient way to detect SPPs in metallic slot waveguides and also offers us a powerful method of probing its properties. By combining these plasmonic detectors with waveguide-integrated LED's, metallic-coated nanocavities or nanowire light sources, the fabrication of a scalable, high-bandwidth plasmonic circuit on-chip can be realized in the near future.

The remote electrical detection of SPPs inside a MIM waveguide by means of a nanoscaled MSM detector allows for the integration of scalable high-bandwidth metallic waveguides in electronic circuits. The opto-electric transduction was realized by means of resonant coupling of propagating surface plasmon polaritons to a waveguide-integrated GaAs MSM detector. Polarization dependent measurements and spectral measurements were performed to prove and study the electrical detection of confined surface plasmon polaritons. e⁻¹ decay lengths of 3.5 μm for 660 nm free space wavelength to 9.5 μm for 870 nm were found. The development and fabrication of these new active plasmonic components opens unique possibilities for both scientific and application-minded research.

By way of example, a fabrication and measurement technique for manufacturing and characterising the system is described below, embodiments of the present invention not being limited thereto.

The waveguide structures were fabricated on a semi-insulating GaAs wafer. By means of molecular beam epitaxy, a 1 μm thick undoped GaAs layer was grown as active layer for the MSM photodetector. After removing the native GaAs oxide, the bottom layer of the MIM waveguide is deposited by sputtering (Au/Ti 100/2 nm). A sub-wavelength gap of 300 nm is defined in negative HSQ resist by e-beam lithography. After exposure to a 100 W oxygen plasma for 20 minutes to harden the resist, the pattern is transferred into the gold layer by ion milling. The titanium adhesion layer and the remaining HSQ are removed in HF. The insulating layer of the MIM structure consists of 90 nm HSQ resist, which obtains a SiO₂-like structure when it is cured for 20 minutes in a 100 W oxygen plasma. HSQ is chosen because of its good planarizing properties for submicrometer structures and for its SiO₂-like optical properties. The top metal layer of the waveguide is also sputter deposited (Au/Ti 160/2 nm). To fabricate the injection slit similar e-beam and ion milling steps were performed as for the detection slit. In the last step the planarization layer is selectively etched on top of the contacts using an optical lithography step in order to access the contact paths by wire bonding or probe needles.

The light from a supercontinuum white light source is coupled into a monochromator in order to select the desired wavelength. The light is linearly polarized and focused by a 100×/0.7 NA Apochromatic long working distance objective onto the sample. Electrical connections are made by wirebonding or probe needles. Electrical readout of the devices was performed with a Keithley 2400 sourcemeter. A XY-piezo scanner mounted on a XYZ-stage enables performance of one and two dimensional scans. At every selected position the current is measured. By scanning the sample in the focal plane one achieves a one or two dimensional map of the photocurrent of the detector. In the 2D photocurrent maps presented in FIG. 8a, the x-axis contains 90 steps of 0.23 μm and the y-axis 70 steps of 0.46 μm. The spectral response in FIG. 9a of the MSM detector was obtained by focusing the laser spot on the injection slit and performing a wavelength sweep.

For the numerical calculations presented in FIG. 6a and FIG. 6b, the RF module of Comsol Multiphysics was used. By using perfectly matched layers, the metals could be extended through the boundaries without introducing any parasitical reflections, allowing us to simulate waveguides with infinite length. For the simulation in FIG. 7 the mode solver of Lumerical FDTD was used.

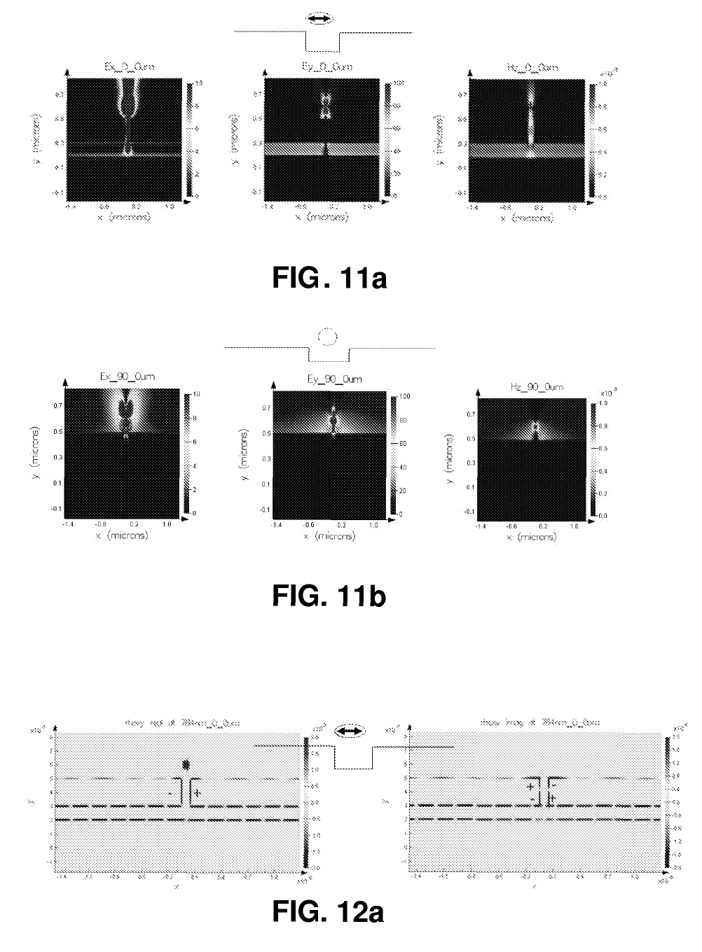

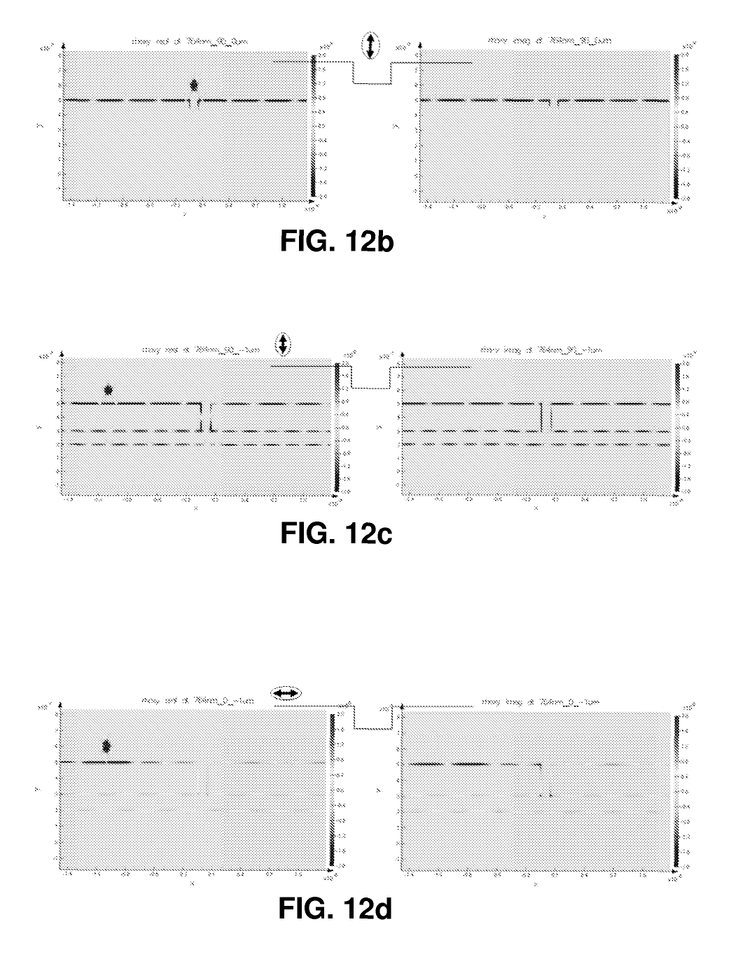

By way of illustration, embodiments of the present invention not being limited thereto, the effect of polarisation on the fluorophore dipole on the coupling and thus the detectability is given below. FIG. 10 illustrates a structure used for simulation (using Lumerical FDTD) of the electric field and charge distribution as function of the polarisation of a fluorophore dipole. The dipole thereby was kept at 100 nm above the metal layer at the top of the structure. A simulation was made of the electric field and charge distribution in the structure over a length of 2 μm, i.e. 1 μm left and right from the input slit. The electric field components in the different directions are shown in FIG. 11a and FIG. 11b for different orientations of the dipole as indicated. It can be seen that for one orientation of the fluorophore dipole, the induced electric field is relatively high, whereas this is not the case for the second orientation. The two different orientations of the fluorophore dipole result in two different perpendicular polarisation states. The corresponding charge density plots are shown in FIGS. 12a and 12b respectively indicating the real and imaginary part of the charge density. It can be seen that the local mode is excited in the injection slit and that for some orientations of the fluorophore dipole an efficient coupling to a propagating waveguide mode is obtained. FIGS. 12c and 12d illustrate the obtained charge density for different positions with respect to the slit, as indicated, resulting in a different charge density behaviour.

Whereas embodiments of the present invention mainly have been described with reference to devices, embodiments of the present invention also relate to methods for detecting an optical signal. The method thereby may comprise steps expressing one or more of the functionalities as provided by one or more components of such devices. For example, in one exemplary embodiment, the present invention relates to a method for detecting an optical signal. The method thereby comprises directing an excitation radiation beam on an altering means for altering optical characteristics of the excitation radiation beam to obtain first radiation. The latter may for example be exciting a plurality of radiation generating or diverting particles, such as for example directing an excitation radiation beam on a set of fluorophores thus generating a first beam. The method also comprises coupling the first radiation via an input slit to a waveguide and propagating said radiation using surface plasmon polaritons towards an output slit. The first radiation, which is coupled out through the output slit, then is detected. In some embodiments, the present invention relates to a method of detecting an optical signal for biosensing, whereby e.g. fluorophores can be coupled to particles of interest and can be located at or near the input slit, such that, if such particles of interest are present, the latter can be detected using e.g. the method as described above. In some embodiments, the excitation radiation is separated from the first radiation through filtering. As indicated above, further method features may correspond with the functionality introduced by components of the devices as described above.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

The foregoing description details certain embodiments of the invention. It will be appreciated, however, that no matter how detailed the foregoing appears in text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

1-26. (canceled)

27. A waveguide integrated photodetector comprising:
a first layer of a plasmon supporting material, the first layer having an input slit extending through the first layer and configured for coupling a first radiation to a waveguide;
a second layer of a plasmon supporting material facing the first layer and separated from the first layer by a first distance in a first direction, the second layer having an output slit extending through the second layer and separated from the input slit by a second distance extending along a second direction different from first direction;
a dielectric layer interposed between the first layer and the second layer, wherein the first layer, the dielectric layer and the second layer combined are configured to act as a waveguide;
a detector configured for detecting radiation coupled out through the output slit; and
at least one component of the group consisting of a fluorescent molecule, a phosphorescent molecule, a quantum dot, a doped nanoparticle, a nanoparticle having luminescent properties, and a magneto-optically active nanoparticle, wherein the component is configured for altering an optical characteristic of an excitation radiation resulting from the first radiation being positioned in the input slit.

28. The waveguide integrated photodetector according to claim 27, wherein the detector is in direct contact with the second layer, is local to the second layer or is in a near field of the second layer.

29. The waveguide integrated photodetector according to claim 27, wherein the component is configured for altering at least one of a wavelength of the excitation radiation or a polarization of the excitation radiation.

30. The waveguide integrated photodetector according to claim 27, wherein the input slit is configured for coupling in the first radiation and for rejecting the excitation radiation.

31. The waveguide integrated photodetector according to claim 27, wherein an interface between the first layer and the dielectric layer supports a first surface plasmon mode.

32. The waveguide integrated photodetector according to claim 27, wherein an interface between the first layer and the dielectric layer supports a second surface plasmon mode.

33. The waveguide integrated photodetector according to claim 27, wherein the input slit is configured for collecting radiation with a predetermined polarization.

34. The waveguide integrated photodetector according to claim 27, wherein a thickness of the first layer is such that the first layer is optically opaque.

35. The waveguide integrated photodetector according to claim 27, wherein a thickness of the second layer is such that the second layer is optically opaque.

36. The waveguide integrated photodetector according to claim 27, wherein a thickness of the dielectric layer is such that the first layer and the second layer optically interact.

37. The waveguide integrated photodetector according to claim 27, wherein a thickness of the dielectric layer is such that the electromagnetic radiation optically couples to the detector.

38. The waveguide integrated photodetector according to claim 27, wherein the second distance is longer than an evanescent tail of an excitation wavelength in the input slit.

39. The waveguide integrated photodetector according to claim 27, wherein the dielectric layer is configured for supporting at least one propagating waveguide mode.

40. The waveguide integrated photodetector according to claim 27, wherein at least one of the first layer or the second layer is a metal.

41. The waveguide integrated photodetector according to claim 27, wherein the detector comprises a semiconducting layer.

42. The waveguide integrated photodetector according to claim 27, further comprising metallic slot waveguides and configured for electrical detection of surface plasmon polaritons in the metallic slot waveguides.

43. The waveguide integrated photodetector according to claim 27, wherein the detector is an integrated metal semiconductor metal detector.

44. The waveguide integrated photodetector according to claim 27, further comprising a filter configured for filtering an excitation radiation from the first radiation.

45. The waveguide integrated photodetector according to claim 44, wherein the filter is a Bragg reflector.

46. The waveguide integrated photodetector according to claim 44, wherein a mechanism of the filter is based on transmission properties of the first radiation and the excitation radiation in the waveguide.

47. A method for detecting an optical signal, the method comprising:
providing a waveguide integrated photodetector according to claim 1;
directing an excitation radiation beam on an altering means for altering optical characteristics of the excitation radiation beam to obtain first radiation;
obtaining the first radiation through alteration of the excitation radiation beam;
coupling the first radiation via an input slit to a waveguide and propagating the radiation using surface plasmon polaritons towards an output slit; and
detecting the first radiation coupled out through the output slit.

48. The method according to claim 47, further comprising filtering the excitation radiation beam from the first radiation beam.
